(19) United States
(12) Patent Application Publication
(10) Pub. No.: US 2003/0024343 A1
(43) Pub. Date: Feb. 6, 2003

(54) Gel padd steering wheel colored covers

(76) Inventor: Michelle La Rey Reynolds Perezlmize, Cupertino, CA (US)

Correspondence Address: Michelle Reynolds, 10815 Peninsular Ave., Cupertino, CA, 95014, US

(21) Appl. No.: 09/919,760

(22) Filed: Jul. 31, 2001

(51) Int. Cl. B62D 1/06

(52) U.S. Cl. 74/558

(57) ABSTRACT

Gel, is not a new product but it is not currently being used at what I think is one of its highest and best uses. It is not being used in the automobile industry at all! There are many computer users that have found a benefit in using computer gel wrist pads. These individuals may also drive a car, but would find their computer gel wrist pads inappropriate and of little use in the car. However, they could benefit in like manner by simply using my gel steering wheel pad cover! On the same note, our population of bikers that use gel bike seat pads also may drive automobiles and would find their gel bike seat covers inappropriate and ill fitted at the wheel of an automobile! Whereas, my gel padded colored steering wheel covers would promote a more comfortable feel at the wheel!

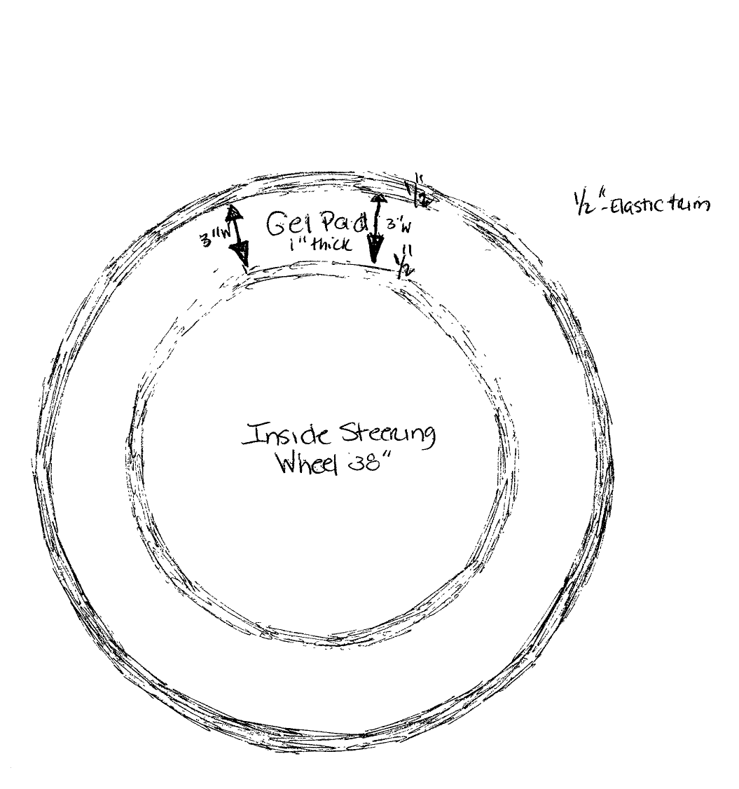

### CROSS REF TO RELATED APPLICATIONS

I believe that the answer to this topic is N/A—none specifically known. I wanted to comment that although the fabric of my invention, gel is a fairly new product on the market used in the computer industry for wrist and mouse pads. Gel padding is not presently being used in the automotive industry. Gel can be used for a new and useful purpose and by design as a steering wheel pad cover in assorted colors.

My gel steering wheel cover was invented to help those with hand and wrist and joint problems, to promote a more comfortable drive, by enhancing the grip by making it a bit softer (like fuzzy faux fur steering wheel covers) and larger. It fits over a regular steering wheel.

### STATEMENT REGARDING FEDERALLY SPONSORED RESEARCH OR DEVELOPMENT/STATEMENT TO A MICROFICHE APPENDIX

Both—N/A, none

### BACKGROUND OF THE INVENTION

1. Field of Endeavor

Automotive

2. Brief History of Invention

I have a hand disease and I went to a hand surgeon years ago to get an experts opinion on why I was losing strength in my right hand, why my fingers curled under, why my joints were swollen, and why my hands hurt a good deal of the time; especially after writing for extended periods of time. I wasn't driving much then, but instead writing a lot! As an alternative to surgery and to thereby avoid extensive physical therapy on my writing hand my doctor suggested over the counter pain killers, muscle relaxes, and that I switch to using pens with bigger grips with padded pen insert covers to eliminate as much hand fatigue as possible.

I have been following my hand specialist's advise for years, with regards to pens. However, as I have aged my hands hurt more, especially after typing on the computer and driving. So, I bought a computer wrist pad on the same premise as the pen. Padded wrist computer pads were found to be benefitial.

Additionally, extending the premise to my car, over the last view years I started using a fuzzy leather steering wheel cover to enhance my grip and increase the comfort of driving long distances. I noticed it helped eliminate excessive hand fatigue to a degree.

When purchasing an SUV this year I noted that luxury cars like the BMW SUV now have a pricey heated steering wheel option; which I would have loved to be able to purchase, but I bought a less expensive SUV and it did have that option.

I did though go out to purchase a new fuzzy faux steering wheel pad to match my new interior and my friend asked me for the old one that matches her interior. I think there is a market for my product as there are only leather, faux leather (i.e. vinyl) and fuzzy faux steering wheel covers available in the automotive parts and accessory stores and I need an even more comfortable steering wheel cover. This is how I thought of my gel steering wheel colored covers. They will be the more affordable option!

Again, I use a gel wrist pad at the computer, but to date could not find a gel steering wheel cover. I do not believe that gel is being used to its fullest and best use. Millions of people use computers everyday and millions of people drive everyday!

### BRIEF SUMMARY OF THE INVENTION

This is a stretchy gel pad steering wheel pad cover, used primarily to increase driving comfort by enhancing the grip with a larger and softer surface. It will be available in different colors to match the color scheme of ones interior fabric/leather upholstery (i.e. black, blue, tan, red or gray) and fun patterns to match taste (i.e. tie-died, cow, or leopard print, etc. . . . ), or with fun sayings on them, (i.e. “Proud Grandparents” “Just Married”, etc. . . . ). Also, dealerships may want to purchase them with their logos on them and I would want patent rights to protect my invention. These gel steering wheel colored covers will be made available to retail drug stores, automotive supply companies and possibly orthopedic supply companies.

### BRIEF DESCRIPTION OF THE SEVERAL VIEWS OF THE DRAWING/BRIEF DESCRIPTION OF THE INVENTION

This made out of gel, like computer wrist pads, but used in a different industry to stretch to cover standard steering wheels. They will have elastic siding approx. 35″ in length, stretching to fit snuggly to accommodate different steering wheel sizes, average approx 38′ around. The gel pad will have leather backing, so it can stretch to conform to different steering wheel shapes. Elastic trim approx. ½ inches going around both edges of the leather strips; similar to my fuzzy faux steering wheel pad is necessary to get a good fit on the steering wheel so it does not slip off. The elastic trim is color coordinated and will secure the gel to the leather. The gel will be approx. 3 inches wide and 1 inch in thickness. (Drawing 1). Again, the advantages of this new useful product will be to help those with carpal tunnel syndrome, arthritis and other diseases of the hands and joints and wrists that make holding a grip for extended periods of time painful and/or uncomfortable.

1.) What I claim as my invention is the use of gel for a steering wheel cover. Restricting others to make a gel steering wheel pad.

2.) I claim it will reduce hand fatigue, immeasurably, but will promote more comfortable driving.

3.) In reference to above, I claim that the elderly and those afflicted with arthritis, and other hand, wrist, joint related problems could especially benefit by using my patented product.
